(19) United States
(12) Patent Application Publication
(10) Pub. No.: US 2016/0203265 A1
(43) Pub. Date: Jul. 14, 2016

(54) METHOD AND MEDICAL IMAGING APPARATUS FOR EXCHANGE OF DATA BETWEEN THE MEDICAL IMAGING APPARATUS AND A USER

(71) Applicant: Siemens Aktiengesellschaft, Muenchen (DE)

(72) Inventors: Donald Hardie, Moehrendorf (DE); Anja Kuerten, Obermichelbach (DE); Stephan Nufer, Erlangen (DE); Thorsten Speckner, Erlangen (DE); Jens Thoene, Nuernberg (DE)

(73) Assignee: Siemens Aktiengesellschaft, Muenchen (DE)

(21) Appl. No.: 14/995,440

(22) Filed: Jan. 14, 2016

(30) Foreign Application Priority Data
Jan. 14, 2015 (DE) 102015200477.5

(51) Int. Cl. G06F 19/00; G06F 3/00; G06F 3/0484; G06K 9/00

(52) U.S. Cl. CPC G06F 19/321; G06K 9/00288; G06F 3/005; G06F 3/04842; G06F 3/04847

(57) ABSTRACT

Situation-dependent data exchange between a user and the medical imaging apparatus is achieved in accordance with the invention by a method for the exchange of data between a medical imaging apparatus having a scanner situated inside an examination room, and a user situated inside the examination room, wherein position data and/or motion data of the user inside the examination room are acquired by a position data acquisition detector, and the position data and/or motion data are evaluated by a data evaluation processor, whereby at least one situation parameter of the user is determined. At least one item of output information is generated by the data evaluation processor in dependence on the at least one situation parameter. The at least one item of output information is presented as an output to the user by a graphical interface situated inside the examination room.

### BACKGROUND OF THE INVENTION

1. Field of the Invention

The present invention concerns a method for an exchange of data between a medical imaging apparatus and a user, in particular a medical operator (technician). To this end, position data and/or motion data are acquired from the user, who is located inside an examination room. The present invention also relates to a medical imaging apparatus with a medical image data scanner, a housing surrounding the scanner, a position data acquisition detector by which the position data and/or motion data of a user can be acquired, a user interface, which includes a graphical interface and is arranged inside an examination room, and a data evaluation processor, wherein the data evaluation processor together with the position data acquisition detector and the user interface is configured to carry out a method for an exchange of data between the medical imaging apparatus and the user.

2. Description of the Prior Art

To prepare for medical imaging examinations, such as a magnetic resonance examination or a computed tomography examination, a user, in particular a medical operator, can retrieve current information selectively. Conventionally, the user must actively retrieve the information he or she requires at the time by selecting the required information from a wide variety of possible and available information.

### SUMMARY OF THE INVENTION

An object of the present invention is to enable a simple and situation-dependent data exchange between a user and the medical imaging apparatus.

The object is achieved in accordance with the invention by a method for the exchange of data between a medical imaging apparatus having a scanner situated inside an examination room and a user situated inside the examination room, with the following steps. Position data and/or motion data of the user inside the examination room are acquired by a position data acquisition detector. The position data and/or motion data are evaluated by a data evaluation processor, whereby at least one situation parameter of the user is determined. At least one item of output information is generated by the data evaluation processor in dependence on the at least one situation parameter. The at least one item of output information is presented as an output to the user by a graphical interface situated inside the examination room.

In this context, a situation parameter means a parameter characterizing or describing a current state of the user, in particular a medical technician, inside the examination room that is relevant to the conductor or supervising of the examination by the technician. For example, the at least one situation parameter can include a current position and/or a current motion of the medical operator. In addition, the at least one situation parameter can include an assignment of the current position and/or current motion to the medical operator. In this context, a user means a medical operator who is preparing the upcoming medical imaging examination. The output information preferably includes a handling instruction and/or information for assisting the user, etc. The output information can also include a request for an input command by the user.

The examination room means the enclosure (complete or partial) in which the medical imaging apparatus, in particular the scanner of the medical imaging apparatus, is situated. Preferably, the examination room is shielded with respect to its exterior and interior in order to prevent disruptive influences that could have an impact on a medical imaging examination from reaching the interior and to prevent influences caused by the medical imaging apparatus from presenting a risk at the exterior. For example, if the medical imaging apparatus is embodied as a magnetic resonance apparatus, the examination room is shielded from the exterior with respect to a magnetic field and from the exterior and interior with respect to electromagnetic radiation, in particular radio-frequency radiation. If the medical imaging apparatus is embodied as a computed tomography apparatus, the examination room can be shielded from the exterior with respect to electromagnetic radiation.

A graphical interface should be understood as being a display monitor and/or an output device for the display and/or graphical presentation of information to a user, in particular a medical operator. The graphical interface can also be configured for the entry of information by inputs made by the medical operator. An input device and an output device of the graphical interface can be embodied together as one component, such as in the form of a touch display.

A touch display should be understood as a touch-sensitive screen with which contact with subareas of the screen, in particular subareas of an image displayed on the screen, enables parameters to be entered, for example to control a program execution.

The invention enables particularly simple data exchange between the user, in particular the medical operator, and the medical imaging apparatus to be achieved. This enables a situation-dependent data exchange so that, during the preparation of the patient for the upcoming medical imaging examination, for example, the medical operator is assisted by the display, in particular a self-activating and/or automatic display, of help settings and/or workflow steps to be performed, etc. In addition, this can provide time-saving assistance for the user since the user can remain inside the examination room to receive the output information and simultaneously actuate further preparatory steps for the preparation of the patient. It is thereby advantageously possible to dispense with the time-consuming retrieval of information by the user. Preferably, the method for an exchange of data between a medical imaging apparatus and a user is controlled in an automatic and self-activating manner by the data evaluation processor of the medical imaging apparatus, with the control by the data evaluation processor taking place in a self-activating and/or automatic manner.

In a further embodiment of the invention, the position data acquisition detector is at least one 2D camera and/or at least one 3D camera by which the position data and/or the motion data are acquired. This enables current position data of the user to be available for the definition of a position and/or a motion of the user. The position data acquisition detector is preferably independent or separate from the scanner of the medical imaging apparatus. In addition, this enables the design of a particularly simple and cost-effective position data acquisition detector.

In a further embodiment of the invention, the at least one situation parameter is determined by at least one face recognition algorithm by the data evaluation unit. This enables an advantageous differentiation to be made between the medical operator and a patient by the automatic and/or self-activating evaluation processor, and hence the exact assignment of an acquired position and/or an acquired motion to the medical operator by the data evaluation processor. In addition, this avoids the output of erroneously assigned output information. The at least one face recognition algorithm is preferably stored in the data evaluation processor, in particular in a memory of the data evaluation processor.

In a further embodiment of the invention, the at least one situation parameter includes a position of the user inside the examination room. This enables a distance from the graphical interface to be determined and output information to be generated in dependence on a value of the distance.

In a further embodiment of the invention, the situation parameter includes an activity of the user. This enables the generation of output information by the data evaluation processor in dependence on the acquired activity of the user and the user to be advantageously assisted in the activity performed by the output information. For example, in the case of the positioning of an ECG unit by the user on the patient, the user is assisted in the positioning of the ECG unit by means of a display of output information preferably including help settings and/or next steps during the process of the positioning of the ECG unit.

In a further embodiment of the invention, a character size of at least one character of the output information can be set in dependence on the at least one situation parameter. It is thereby possible to adapt a character size of the output information in dependence on the position of the user, in particular a distance of the user from the graphical interface. The greater thereby the distance of the user from the graphical interface, the larger the character size of at least one character of the output information can be selected. The character size is preferably set by means of the data evaluation processor.

In another embodiment of the invention, an assignment of the at least one situation parameter to at least one item of output information is performed in a learning step. This enables a particularly reliable and virtually error-free assignment between the at least one situation parameter and at least one item of output information to be performed by the data evaluation processor. In addition, this particularly efficiently enables a user to be assisted in a current situation, for example a preparatory activity to be performed, such as, in particular, the application of local radio-frequency antenna units for an upcoming magnetic resonance examination. In addition, this can achieve a particularly time-saving sequence of operations or workflow for the user since the time-consuming retrieval of a support program by the user on an operator console can advantageously be dispensed with. In this context, a learning step should in particular be understood to mean a step that, for a current assignment, refers to assignments that have already been made and thereby compares the different situations by a comparison of the individual situation parameters with one another. The individual assignments can thereby be stored in a database of the data evaluation processor and/or a memory of the data evaluation processor.

In a further embodiment of the invention, the graphical interface includes a surface of a housing of the medical imaging examination facing the operator and at least one output field and/or at least one input field of the graphical interface is selected in dependence on the at least one situation parameter. The graphical interface preferably includes a touch display including the at least one input field and/or the at least one output field. In this way, it is possible, in dependence on a position of the user with reference to the graphical interface, for the corresponding output fields and/or input fields of the graphical interface to be selected by the data evaluation processor in an automatic or self-activating manner. If, for example, the user is located on the right side of the patient support apparatus, the result is that the data evaluation processor also uses the right side of the surface of the housing facing the user for the corresponding output fields and/or input fields. If the user instead chooses a position of the user on the left side of the patient support apparatus, the result is that that the data evaluation processor also uses the left side of surface of the housing facing the user for the corresponding output fields and/or input fields.

Alternatively or additionally, a number of the input fields and/or output fields displayed on the graphical interface can be set in dependence on the at least one situation parameter. It is thereby possible to dispense with a display of input fields on the graphical interface, if the user has a distance from the graphical interface that makes a spontaneous entry on the graphical interface impossible without a position change on the part of the user. In a situation of this kind, the additional display area on the graphical interface obtained by the omission of the input fields unit can be available in the form of additional output fields so that additional information can be displayed and/or output with a larger character size.

The invention also concerns a medical imaging apparatus with a scanner and a housing surrounding the scanner. In addition, the medical imaging apparatus has a position data acquisition detector by which position data and/or motion data of a user can be acquired, a user interface, which includes a graphical interface arranged inside an examination room, and a data evaluation processor. The data evaluation processor is configured together with the position data acquisition detector and the user interface to carry out a method for an exchange of data between the medical imaging apparatus and the user as described above.

It is advantageously possible to achieve a particularly simple data exchange between the user, in particular the medical operator, and the medical imaging apparatus. In this way, there can be a situation-dependent data exchange so that, during the preparation of the patient for the upcoming medical imaging examination, for example, the medical operator is advantageously assisted by the display, in particular by a self-activating and/or automatic display, of help settings and/or workflow steps to be performed, etc. In addition, this apparatus can provide particularly time-saving assistance for the user since the user can remain inside the examination chamber to receive the output information and simultaneously actuate further preparatory steps for the preparation of the patient. In this case, the time-consuming retrieval of information by the user is not needed.

The advantages of the medical imaging apparatus according to the invention substantially correspond to the advantages of the method for an exchange of data between a medical imaging apparatus and a user according to the invention, as explained above. Features, advantages or alternative embodiments are applicable to all aspects of the invention.

In an embodiment of the medical imaging apparatus, the position data acquisition detector is at least one 2D camera and/or at least one 3D camera. This enables the provision of a particularly simple and cost-effective position data acquisition detector. In addition, this enables current position data and/or image data for the data exchange between the medical imaging apparatus and the user to be continuously available. In particular, the position data and/or image data can be present in real time.

In a further embodiment of the invention, the graphical interface includes a touch display. This enables in a particularly simple way a display of information and the entry of parameters and/or positioning information. In addition, this provides particularly simple operability, in particular intuitive operation, of the graphical interface for the user, in particular the medical operator. The touch display can be situated directly on the medical imaging apparatus so that the medical operator does not have to leave an examination room in which the medical imaging apparatus is situated. The touch display is preferably integrated in the housing. For this purpose, the touch display can be fixed on the housing or arranged detachably on the housing.

In a further embodiment of the invention, the graphical interface includes a surface of the housing facing the user. This enables a particularly space-saving arrangement of the graphical interface in the medical imaging apparatus. Moreover, good visibility can be achieved for a user. Preferably, the surface of the housing included by the graphical interface is a front side and/or front surface of the housing of the medical imaging apparatus, so that advantageous assistance can be provided during the preparation of a patient for a medical imaging examination by the graphical interface. This also enables advantageous accessibility of the graphical interface from a preparation area for a medical operator, for example for entering parameters and/or control commands.

In a further embodiment of the invention, the graphical interface has at least one output field and/or at least one input field. One variable of the at least one output field and/or one variable of the at least one input field, and/or a number of input fields and/or a number of output fields, can be selected by the data evaluation processor in dependence on at least one situation parameter. It is thereby possible, for example in dependence on a situation parameter including a position of the user, in particular a distance of the user from the graphical interface, for a character size of the output information to be adjusted while the information content of the output information remains the same, since the number of the output fields that can be activated and/or are activated for the presentation of the output information can be increased. The greater the distance of the user from the graphical interface, the greater the character size of at least one character of the output information so that, dependent on the distance of the user from the graphical interface, the number of output fields that can be activated, and/or activated for the presentation of the output information, is increased. In addition, it is also possible to dispense with a display of input fields on the graphical interface if the at least one situation parameter includes information that the user has a distance from the graphical interface that makes a spontaneous entry impossible without a change of position on the part of the user. For example, in a situation of this kind, additional output fields can be made available in an additional display area on the graphical interface being made available by the omission of the input fields. Thus additional information can be displayed for the user and/or the same information content can be presented with a larger character size.

In a further embodiment of the invention, the medical imaging apparatus has a patient support apparatus configured to support the patient for a medical imaging examination, wherein the graphical interface includes at least two input fields, the at least two input fields being situated respectively on different sides of the patient support apparatus. In this way, with different preparatory activities on the patient support apparatus, a user, in particular a medical operator, always has direct access to one of the input fields without having to change position. Preferably, the different sides at the input fields of the graphical interface are situated opposite each other.

The invention concerns a non-transitory, computer-readable data storage medium that can be loaded directly into a memory of a programmable data evaluation processor of a medical imaging apparatus. The storage medium is encoded with program code (instructions) to carry out the method according to the invention when the program code is executed in the data evaluation processor of the medical imaging apparatus. The program code may require program means, such as libraries and auxiliary functions, in order to implement the embodiments of the method. The program code can be software in a source code, which still has to be compiled and linked or only has to be interpreted, or can be executable software code, which only has to be loaded into the corresponding computer for execution.

### BRIEF DESCRIPTION OF THE DRAWINGS

FIG. 1 schematically illustrates a medical imaging apparatus according to the invention.

FIG. 2 schematically shows a first exemplary embodiment of a graphical interface of the medical imaging apparatus.

FIG. 3 schematically shows a second exemplary embodiment of a graphical interface of the medical imaging apparatus.

FIG. 4 is a flowchart of the method according to the invention.

### DESCRIPTION OF THE PREFERRED EMBODIMENTS

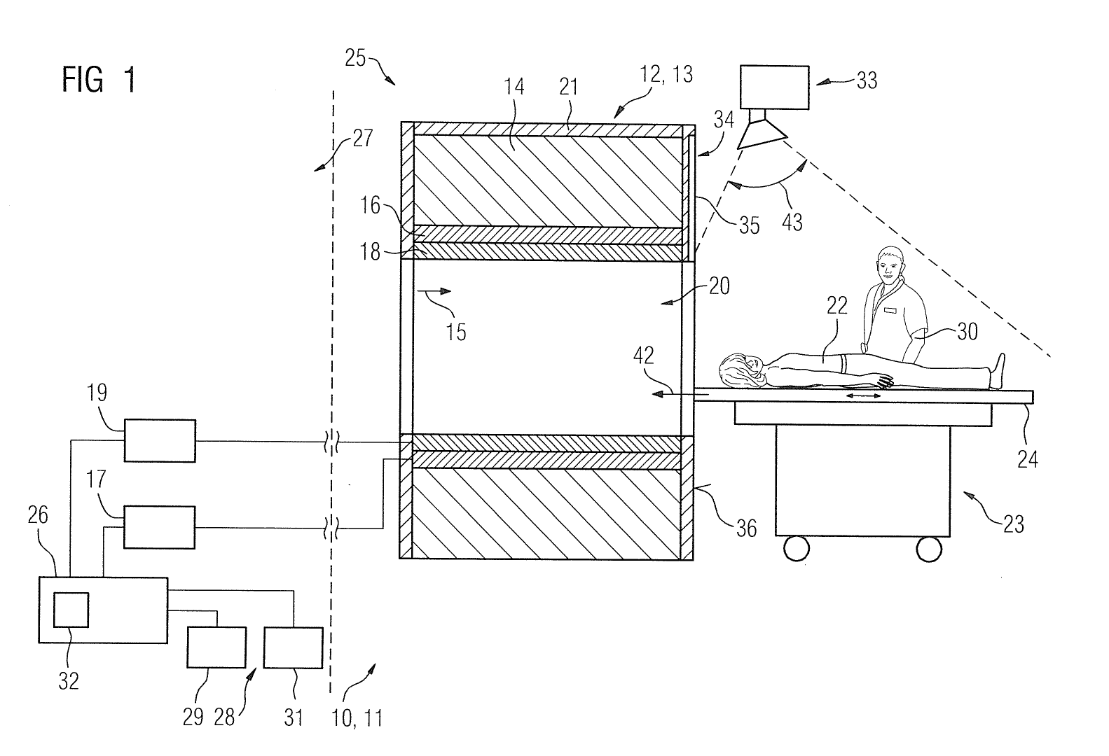

FIG. 1 schematically illustrates a medical imaging apparatus 10. In the present exemplary embodiment, the medical imaging apparatus 10 is formed as a magnetic resonance apparatus 11. However, the design of the medical imaging apparatus 10 is not restricted to a magnetic resonance apparatus 11. This can be any imaging apparatus that is considered appropriate to those skilled in the art, such as a computed tomography apparatus, a positron emission tomography apparatus, etc.

The medical imaging apparatus 10 has an image data detector 12, which, in the present exemplary embodiment, is formed by a scanner 13 of the magnetic resonance apparatus 11. The scanner 13 has a superconducting basic field magnet 14 for the generation of a strong and constant basic magnetic field 15. The scanner 13 also includes a gradient coil arrangement 16 for generating magnetic field gradients that are used for spatial encoding during imaging. The gradient coil arrangement 16 is controlled by a gradient control processor 17 of the magnetic resonance apparatus 11. The scanner 13 also includes a radio-frequency antenna 18 for exciting nuclear spins in an examination subject in the scanner 13 to deviate from the polarization that is established by the basic magnetic field 15 generated by the basic field magnet 14. The radio-frequency antenna 18 is controlled by a radio-frequency antenna control processor 19 of the magnetic resonance apparatus 11 and radiates radio-frequency magnetic resonance sequences into an examination volume, which is substantially formed by a patient receiving area 20 of the scanner 13.

The detector 12, in the present exemplary embodiment, the scanner 13, is surrounded by a housing 21.

The patient receiving area 20 receives a patient 22. In the present exemplary embodiment, the patient receiving area 20 has a cylindrical shape and is surrounded in a circumferential direction by the scanner 13. A decision of the patient receiving area 20 deviating therefrom is also possible. The patient 22 can be moved into the patient receiving area 20 by a patient support 23 of the medical imaging apparatus 10. The patient support 23 has a patient table 24 that is movable inside the patient receiving area 20.

The detector 12, in particular the scanner 13, is situated together with the housing 21 and the patient support apparatus 23 inside an examination room 25. The examination room 25 is shielded with respect to electromagnetic radiation and/or with respect to the propagation of magnetic fields.

To control the medical imaging apparatus 10, for example, to control the basic field magnet 14, the gradient control processor 17, and the radio-frequency antenna control processor 29, the medical imaging apparatus 10 has a system control computer 26. The system control computer 26 is arranged inside a control room 27, which is separate from the examination room 25. In particular, the control room 27 is decoupled from the examination room 25 with respect to the propagation of magnetic fields.

The system control computer 26 operates the magnetic resonance apparatus 11 centrally, such as, for example, for the performance of a predetermined imaging gradient echo sequence. The system control computer 26 also includes an evaluation processor (not shown), for the evaluation of medical image data acquired during a magnetic resonance examination. In addition, the medical imaging apparatus 10 includes a control console 28 connected to with the system control computer 26 and arranged inside the control room 27. Control information such as imaging parameters, and reconstructed magnetic resonance images can be displayed on a display component 29, for example on at least one monitor, of the control console 28 for a medical operator 30. Moreover, the control console 28 has an input component 31 via which information and/or parameters can be entered by the medical operator 30 during a data acquisition procedure.

For data exchange between the medical imaging apparatus 10, in particular the magnetic resonance apparatus 11, and a user, such as a medical operator 30, the medical imaging apparatus 10 also has a data evaluation processor 32, a position data acquisition detector 33 and a user interface 34 with a graphical interface 35. In this case, the position data acquisition detector 33 and the user interface 34 with the graphical interface 35 are arranged inside the examination room 25.

The data evaluation processor 32 is included in the system control computer 26 and is arranged inside the control room 27. For data exchange between the data evaluation processor 32 and the position data acquisition detector 33 and data exchange between the data evaluation processor 32 and the graphical interface 34, the medical imaging apparatus 10 has one or more data transmission paths (not shown).

The position data acquisition detector 33 is configured to acquire position data and/or motion data of the user. The position data acquisition detector 33 can be a 2D camera or a 3D camera. It is also possible for the position data acquisition detector 33 to include two or more 2D cameras and/or two or more 3D cameras.

The position data acquisition detector 33, in particular the 2D camera or the 3D camera, is arranged inside the examination room 25. The position data acquisition detector 33 is situated inside the examination room 25 such that a motion and/or a position of the user, in particular the medical operator 30, can be acquired during the preparation of a patient 22 for a medical imaging examination, in particular a magnetic resonance examination, and/or during a medical imaging examination, in particular during a magnetic resonance examination. For the preparation of a patient 22 for a medical imaging examination and/or during the medical imaging examination, the user is generally located in a region that is in the direction of an insertion movement 42 of the patient table 24 into the patient receiving area 20, thus at a front side 36 of the medical imaging apparatus 10. In the present exemplary embodiment, the position data acquisition detector 33 is arranged in a coverage area inside the examination room 25 such that a field of view 43 of position data acquisition detector 33 covers the area at the front side 36 of the medical imaging apparatus 10. However, an arrangement of the position data acquisition detector 33 deviating therefrom is also possible.

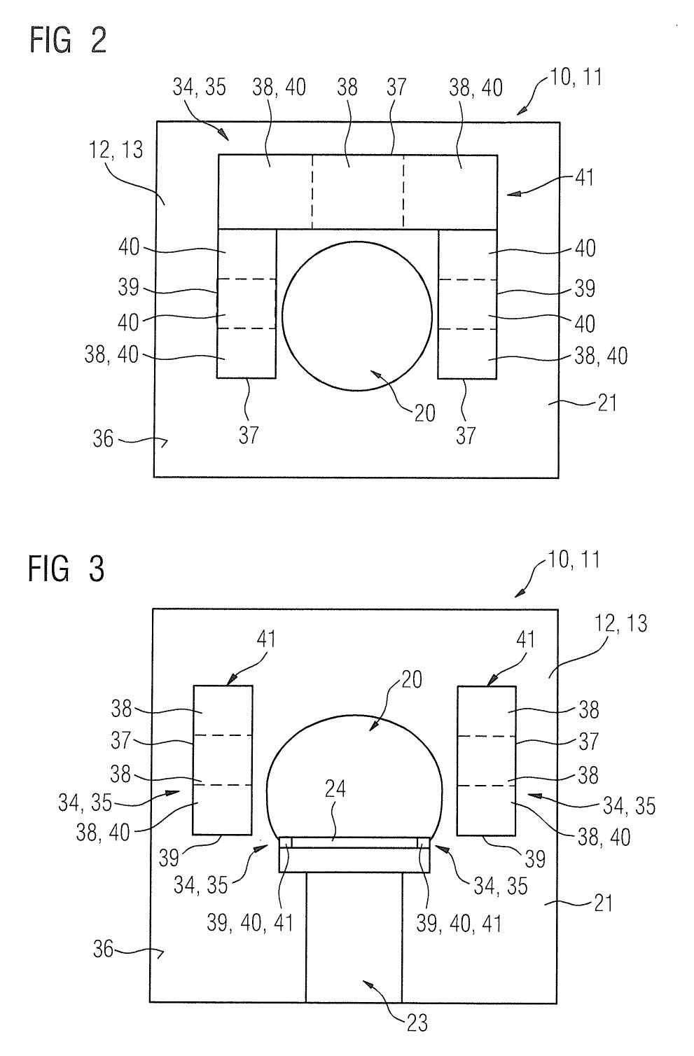

FIGS. 2 and 3 are two different embodiments of the graphical interface 35 of the user interface 34. In each of FIGS. 2 and 3, the graphical interface 35 of the user interface 34 has an output component 37 with at least one output field 38 and an input component 39 with at least one input field 40.

In the exemplary embodiment in FIG. 2, the graphical interface 35 has a touch display 41 that includes both the output component 37 and the input component 39. The graphical interface 35 includes a surface of the housing facing the user 21, wherein the user performs an activity for the preparation of the patient 22 for the medical imaging examination and/or an activity for supporting the medical imaging examination. In the present exemplary embodiment, the graphical interface 35 includes the front side 36 of the housing 21.

Alternatively, the graphical interface 35, in particular the touch display 41, can be arranged detachably on the housing 21.

The graphical interface 35 can include a single touch display 41, as shown in FIG. 2. The graphical interface 35 alternatively can include two or more touch displays 41, which can be arranged on both sides around an insertion aperture of the patient receiving area 20 on the housing 21, wherein each of the two touch displays 41 has an output component 37 and an input component 39. It is also possible for the graphical interface 35 to have an output component 37 embodied separately from the input component 39 thereof. For example, the output component 37 can be embodied as a simple monitor. The input component 39 can in this case be formed by a touch display.

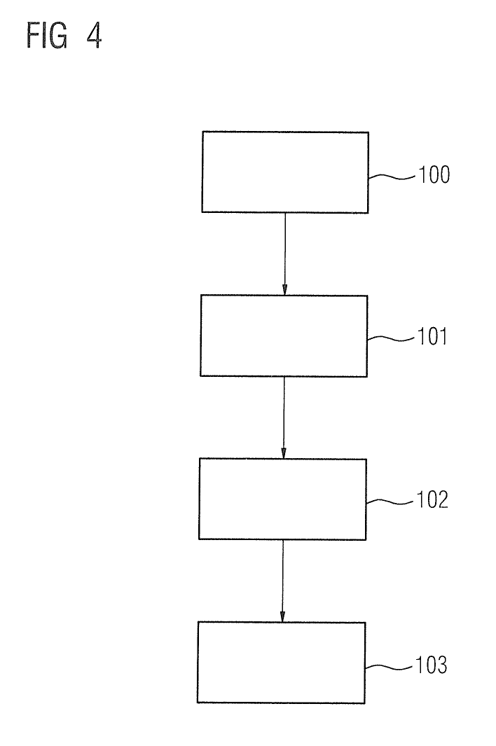

In the exemplary embodiment in FIG. 2, the input component 39 has two or more component input fields 40. The output component 37 also has two or more output fields 38. The data evaluation processor 32 determines whether a field of the graphical interface 35 is activated as an output field 38 or an input field 40 and hence included by the output component 37 or the input component 39, as will be described below with reference to FIG. 4.

In the exemplary embodiment in FIG. 3, the graphical interface 35 also includes an output component 37 and an input component 39. The output component 37 is at least partially embodied separate from the input component 39. The output component 37 can be embodied as a simple monitor or also as a touch display 41 arranged on and/or integrated in the front side 36 of the housing 21. The output component 37 has at least one output field 38. In the exemplary embodiment, the output unit has two or more output fields 38, which are arranged on opposite sides of an insertion aperture of the patient receiving area 20 on the housing 21.

Further embodiments of the output component 37 and/or arrangement variants of the output component 37 on the front side 36 of the housing 21 are possible.

In the exemplary embodiment in FIG. 3, the input component 39 is arranged on the patient support apparatus 23. The input component 39 has two or more input fields 40, which are preferably formed by a touch display. In an alternative embodiment of the invention, an embodiment of the input fields 40 with a keyboard and/or simple key elements is possible. The two input fields 40 are in each case arranged on an edge area of the patient support apparatus 23, wherein the edge areas are arranged on opposite sides of the patient support apparatus. The two edge areas of the patient support apparatus 23 are arranged in the direction of a transverse extension, perpendicular to an insertion movement of the table 24, of the patient support apparatus 23, on opposite sides of the patient support apparatus 23. This provides the user with direct visibility of the input fields 40 during the preparation of a patient 22 for the upcoming medical imaging examination. The embodiment of the input components 39 as a touch display enables the input fields 40 also to take on the function of the output component 37, in particular the output fields 38 of the output component 37. This enables the touch displays arranged on the patient support apparatus 23 to include both input fields 40 of the input unit 39 and output fields 38 of the output component 37.

In addition to the input component 39 being arranged on the patient support apparatus 23, it is possible for the graphical interface 35 to have a further input component 39 arranged on the front side 36 of the housing 21.

FIG. 4 shows a method according to the invention for an exchange of data between the medical imaging apparatus 10 and the user, who is arranged inside the examination room 25. The method is executed by the data evaluation processor 32 together with the position data acquisition detector 33 and the user interface 34 with the graphical interface 35. To this end, the data evaluation computer 32 has computer programs and/or software to carry out the method according to the invention when executed by a processor of the data evaluation computer 32. The computer programs and/or the software are stored in a memory of the data evaluation computer 32 (not shown).

In a first method step 100, the position data acquisition detector 33 acquires position data and/or motion data of the user, in particular of the medical operator 30, inside the examination room 25. The 2D camera or the 3D camera acquires two-dimensional or three-dimensional position data and/or motion data. Preferably, the user, in particular the medical operator 30, is located together with the patient 22 inside the examination room 25 in order to prepare the patient 22 for an upcoming medical imaging examination, or even during the medical imaging examination.

In a further method step 101, the acquired position data and/or motion data are transmitted by the data transmission path to the data evaluation processor 32 where the data are evaluated. In the further method step 101, the data evaluation processor 32 determines or establishes at least one situation parameter with reference to the position data and/or the motion data. In the present exemplary embodiment, two or more situation parameters are determined and/or established thereby with reference to the acquired position data and/or motion data by the data evaluation processor 32. The data evaluation processor 32 includes a face recognition algorithm so that an assignment of a position and/or a activity to a defined person by means of the data evaluation processor 32 can be performed with reference to the acquired position data and/or motion data and/or a differentiation between the patient 22 and the medical operator 30 can be performed by the data evaluation processor 32. The results of the face recognition algorithm are taken into account in the determination of the at least one situation parameter by the data evaluation processor 32.

In this case, at least one situation parameter can include a position of the medical operator 30 inside the examination room 25. In addition, at least one situation parameter can include a distance of the medical operator 30 from the detector unit 12 and/or the graphical interface 35. The data evaluation processor 32 is thus able, with reference to the acquired position data and/or motion data, to differentiate between a distance of the medical operator 30 from one of the output fields 38 of graphical interface 35 and a distance of the medical operator 30 from one of the input fields 40 of the graphical interface 35. These different distances can then be indicated by the data evaluation processor 32 in two different situation parameters.

In addition, at least one situation parameter can include an activity of the medical operator 30. The situation parameter can thereby indicate whether the medical operator 30 places an auxiliary unit, such as, for example, a local radio-frequency coil or an ECG unit, on the patient 22 during the preparation of the patient 22 for the upcoming imaging examination or positions the actual patient 22 on the patient table 24, etc. In particular, the data evaluation processor 32 establishes individual steps of an activity currently performed by the medical operator 30 with reference to the position data and/or the motion data, and indicates this activity in at least one situation parameter.

In a further method step 102, the data evaluation processor 32 generates at least one item of output information, which is generated in dependence on at least one of the situation parameters. In the further method step 102, the data evaluation processor 32 sets a character size of characters of the output information in dependence on the situation parameter, in particular the situation parameter that includes a distance of the medical operator 30 from the output component 37 of the graphical interface 35. The greater a distance of the medical operator 30 from the output component 37 of the graphical interface 35, the larger the character size selected by the data evaluation processor 32. This always ensures advantageous legibility and/or advantageous visibility of the output information for the medical operator 30.

For the generation of the output information, in the method step 102, the data evaluation processor 32 can also assign a situation parameter to an item of output information by execution of a learning step. To this end, the data evaluation processor 32 has one or more image processing algorithms, which, for example with reference to a situation parameter including an activity currently being performed by the medical operator 30, select at least one item of output information required for the activity, for example in the form of instructions containing a next preparatory step and/or in the form of hazard notifications indicating a current hazardous situation, etc., from a wide variety of available items of output information. Preferably the available output information, and also optionally the assignment thereof to a situation parameter, is stored in a database of the data evaluation unit 32. The data processing unit 32 can thereby refer to assignments that have already been made for a current assignment and in this case, a current item of output information can be obtained by means of a comparison of the current situation parameter with individual stored situation parameters and the output information thereof.

This learning step can also include interaction of the medical operator 30 so that any possible faulty assignment by the data evaluation processor 32 can be corrected.

The output information generated in method step 102 can contain information that is exclusively configured to be emitted by the output component 37, such as a handling instruction and/or a help setting for a workflow step to be performed, etc. The output information generated in method step 102 can also include a request to the user, in particular to the medical operator 30, to enter information and/or parameters and/or to confirm selected information, etc., such as a confirmation that a handling instruction and/or a workflow step to be performed has already been processed.

In a further, subsequent method step 103, first the output information by the data evaluation processor 32 is transmitted to the graphical interface 35 and then the output information is presented. In this further method step 103, the presentation of the output information can be performed by the output component 37 and also by the input component 39. This is advantageous if the output information also includes a request to the user, in particular to the medical operator 30, to enter information and/or parameters and/or for the confirmation of selected information etc. An input field 40 of the input component 39 can in this case also be embodied as an output field 38 of the output component 37 due to its embodiment as a touch display 41.

In this further method step 103, the output and/or display of the output information can also be performed in dependence on at least one situation parameter. Thereby, in the further method step 103, one variable of one output field 38 or a plurality of output fields 38 or one variable of an input field 40 or a number of input fields 40 can be activated with reference to a situation parameter or a number of situation parameters by the data evaluation processor 32. Moreover, it is also possible for a number of output fields 38 and/or a number of input fields 40 to be selected or activated with reference to a situation parameter or a number of situation parameters by the data evaluation processor 32.

For example it is possible, in dependence on the situation parameter that includes a distance of the medical operator 30, in particular the head of the medical operator 30, from the graphical interface 35, for an output field 37 or even multiple output fields 37 to be defined and/or activated. In addition, it is possible, in dependence on the situation parameter that includes a distance of the medical operator 30, in particular the head of the medical operator 30, from the graphical interface 35, for an input field 40 or even a number of input fields 40 to be defined and/or activated.

For example, it is possible for an input field 40 and/or an output field 38 of the graphical interface 35 arranged in a visual field and/or a visual area of the medical operator 30 to be activated by the data evaluation processor 32. In addition, it is possible for the input field 40 and/or the output field 38 of the graphical interface 35 with the shortest distance from the medical staff to be activated by the data evaluation processor 32. The graphical interface 35 can be designed according to one of the exemplary embodiments in FIG. 2 or FIG. 3. For example, in this case, it is possible for the data evaluation processor 32 to activate the input field 40 on the patient support apparatus 23 in FIG. 3 with the shortest distance from the medical operator 30. If the medical operator 30 is located on the right next to the patient support apparatus 23, the data evaluation processor 32 activates the input field 40 arranged on the right edge area of the patient support apparatus 23. If the medical operator 30 is located to the left of the patient support apparatus 23, the data evaluation processor 32 activates the input field 40 arranged on the left edge area of the patient support apparatus 23.

Similarly, it is also possible for the data evaluation processor 32 to make a position-dependent selection of one of the input fields 40 on the touch display 41 of the graphical interface 35 shown in FIG. 2.

In addition, it is possible in the further method step 103, in dependence on a situation parameter that includes an activity of the medical operator 30, for a number of output fields 37 and/or a number of input fields 40 to be selected or activated by the data evaluation processor 32 with reference to the situation parameter. If the acquired activity includes an activity, which is, for example, only performed rarely not included in the routine activities of the medical operator 30, it is possible for a number of output fields 38 on which output information to assist the medical operator 30 in this activity can be output to be selected and/or activated by the data evaluation processor 32. In addition, for different activities, the medical operator can be shown different help settings in the form of output information in order to assist the medical operator in a sequence of operations or to warn the medical operator of possible hazardous situations.

In the further method step 103, it is also possible with reference to a situation parameter including a distance of the medical operator 30 from the graphical interface 35, for the data evaluation processor 32 to specify a number of activated output fields 38 and/or a number of activated input fields 40. If, for example, a distance of the medical operator 30 from the graphical interface 35 is so large that the distance does not permit input, the result can be a deactivation of the input fields 40 by the data evaluation processor 32. The area of the graphical interface 35 available as a result of the deactivation can be used for additional output fields 38. This enables additional information to be shown to the medical operator 30 or also for the information displayed to be presented with a larger character size. Preferably, the graphical interface 35 includes the touch display 41 as shown in more detail in FIG. 2.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for exchange of data between a control computer of a medical imaging apparatus, said medical imaging apparatus comprising a medical data acquisition scanner configured to interact with a patient to acquire medical image data from the patient in an examination procedure supervised by a medical technician, said medical technician and said scanner being situated inside an examination enclosure, said method comprising:
operating a technician data detector to acquire technician data selected from the group consisting of position data that represent a position of the technician inside the examination enclosure and motion data that represent motion of the technician inside the examination enclosure;
providing said technician data to said control computer and, in said control computer, evaluating said technician data to identify a situation parameter of the technician that represents a current state of the technician in said examination procedure;
in said control computer, formulating output information dependent on said situation parameter; and
situating a graphical interface in said examination enclosure at a location visible to the technician inside said examination enclosure, and communicating said output information from said control computer to said graphical interface for presentation to the technician at said location inside said examination enclosure.

2. A method as claimed in claim 1 comprising using a camera selected from the group consisting of 2D cameras and 3D cameras as said position data acquisition detector.

3. A method as claimed in claim 1 comprising generating said situation parameter in said control computer by executing a face recognition algorithm so that said situation parameter is specific to said technician.

4. A method as claimed in claim 1 comprising generating said situation parameter to designate a position of the technician inside the examination enclosure.

5. A method as claimed in claim 1 comprising generating said situation parameter to designate an activity of the technician in said examination enclosure.

6. A method as claimed in claim 1 comprising presenting said output information at said graphical interface as text having a character size, and setting said character size dependent on said situation parameter.

7. A method as claimed in claim 1 comprising formulating said output information by correlating at least one situation parameter to at least one item of output information in said control computer in a learning procedure.

8. A method as claimed in claim 1 wherein said scanner comprises a housing and wherein said graphical interface comprises an output field at which said output information is presented, and wherein said method comprises situating said graphical interface in said examination enclosure on a surface of said housing of said scanner with said output field facing said technician, dependent on said situation parameter.

9. A method as claimed in claim 8 wherein said graphical interface comprises a plurality of output fields available for presentation of said output information, and wherein said method comprises, in said computer, selecting at least one of said output fields for presentation of said output information dependent on said situation parameter.

10. A method as claimed in claim 1 wherein said graphical interface comprises at least one input field configured to receive an input to said control computer, via said graphical interface, by manual interaction with the technician.

11. A method as claimed in claim 10 wherein said graphical interface comprises a plurality of input fields, and comprising, in said control computer, selecting one said input fields for receiving said input from said technician dependent on said situation parameter.

12. A medical imaging apparatus comprising:
a medical data acquisition scanner configured to interact with a patient to acquire medical image data from the patient in an examination procedure supervised by a medical technician, said medical technician and said scanner being situated inside an examination enclosure;
a technician data detector configured to acquire technician data selected from the group consisting of position data that represent a position of the technician inside the examination enclosure and motion data that represent motion of the technician inside the examination enclosure;
a control computer provided with said technician data, said control computer being configured to evaluate said technician data to identify a situation parameter of the technician that represents a current state of the technician in said examination procedure;
said control computer being configured to formulate output information dependent on said situation parameter; and
a graphical interface situated in said examination enclosure at a location visible to the technician inside said examination enclosure, and said control computer being configured to communicate said output information from said control computer to said graphical interface for presentation to the technician at said location inside said examination enclosure.

13. A medical imaging apparatus as claimed in claim 12 wherein said technician data detector comprises using a camera selected from the group consisting of 2D cameras and 3D cameras.

14. A medical imaging apparatus as claimed in claim 12 wherein said control computer is configured to generate said situation parameter by executing a face recognition algorithm so that said situation parameter is specific to said technician.

15. A medical imaging apparatus as claimed in claim 12 wherein said control computer is configured to generate said situation parameter to designate a position of the technician inside the examination enclosure.

16. A medical imaging apparatus as claimed in claim 12 wherein said control computer is configured to generate said situation parameter to designate an activity of the technician in said examination enclosure.

17. A medical imaging apparatus as claimed in claim 12 wherein said control computer is configured to present said output information at said graphical interface as text having a character size, and to set said character size dependent on said situation parameter.

18. A medical imaging apparatus as claimed in claim 12 wherein said control computer is configured to formulate said output information by correlating at least one situation parameter to at least one item of output information in said control computer in a learning procedure.

19. A medical imaging apparatus as claimed in claim 12 wherein said scanner comprises a housing and wherein said graphical interface comprises an output field at which said output information is presented, and wherein said graphical interface is situated in said examination enclosure on a surface of said housing of said scanner with said output field facing said technician, dependent on said situation parameter.

20. A medical imaging apparatus as claimed in claim 19 wherein said graphical interface comprises a plurality of output fields available for presentation of said output information, and wherein said control computer is configured to select at least one of said output fields for presentation of said output information dependent on said situation parameter.

21. A medical imaging apparatus as claimed in claim 12 wherein said graphical interface comprises at least one input field configured to receive an input to said control computer, via said graphical interface, by manual interaction with the technician.

22. A medical imaging apparatus as claimed in claim 21 wherein said graphical interface comprises a plurality of input fields, and wherein said control computer is configured to select one said input fields for receiving said input from said technician dependent on said situation parameter.

23. A non-transitory, computer-readable data storage medium encoded with programming instructions, said storage medium being loaded into a control computer of a medical imaging apparatus that comprises a medical image data acquisition scanner situated inside an examination enclosure for acquiring medical image data from a patient in an examination procedure supervised by a medical technician in the examination enclosure, said programming instructions causing said control computer to:
operate a technician data detector to acquire technician data selected from the group consisting of position data that represent a position of the technician inside the examination enclosure and motion data that represent motion of the technician inside the examination enclosure;
evaluate said technician data to identify a situation parameter of the technician that represents a current state of the technician in said examination procedure;
formulate output information dependent on said situation parameter; and
select a location at a graphical interface, dependent on said situation parameter, in said examination enclosure that is visible to the technician inside said examination enclosure, and communicate said output information from said control computer to said graphical interface for presentation to the technician at said location inside said examination enclosure.
